(19) United States
(12) Patent Application Publication
(10) Pub. No.: US 2016/0320839 A1
(43) Pub. Date: Nov. 3, 2016

(54) WEARABLE TERMINAL AND SYSTEM INCLUDING SAME

(71) Applicant: LG ELECTRONICS INC., Seoul (KR)

(72) Inventors: Hyojin SONG, Seoul (JP); Sanjo PARK, Seoul (KR); Dongyoung LEE, Seoul (KR); Soonbo HAN, Seoul (KR)

(21) Appl. No.: 15/108,864

(22) PCT Filed: Jun. 18, 2014
(86) PCT No.: PCT/KR2014/005356

§ 371 Date: Jun. 29, 2016

(30) Foreign Application Priority Data
Jan. 27, 2014 (KR) 10-2014-0009727

(51) Int. Cl. G06F 3/01; H04B 1/3827; G06F 3/0346; G06F 1/16; G06F 3/03

(52) U.S. Cl. CPC G06F 3/015; G06F 1/163; G06F 3/013; G06F 3/0304; G06F 3/0346; H04B 1/385; H04B 2001/3866

(57) ABSTRACT

The present invention relates to a wearable terminal for storing data according to biometric information of a user, and a system. The wearable terminal of the present invention comprises: a communication unit for communicating with at least one external device; a memory for storing a photographed image and/or a detected sound; a biometric information detection unit for detecting biometric information from the body of the user; and a control unit for controlling the communication unit so as to transmit the stored image and/or sound to the external device according to the detected biometric information.

### TECHNICAL FIELD

The present invention relates to a wearable terminal configured to store data according to biometric information of a user, and a system.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

A function of a terminal is diversifying. For instance, the function of the terminal may include capturing a picture or a video, playing a music file or a video file, playing an electronic game and receiving broadcasting and the like. The terminal is implemented in such a type as a multimedia player equipped with the aforementioned complex functions.

Besides the aforementioned functions, it is required for a terminal to have a function of automatically storing information on a daily life of a user and providing the user with information necessary for the user. In order to support and enhance the function of the terminal, it may consider improving a structural part and/or a software part of the terminal.

### DISCLOSURE OF THE INVENTION

### Technical Task

Accordingly, the present invention is directed to an apparatus and method thereof that substantially obviate one or more problems due to limitations and disadvantages of the related art. An object of the present invention is to provide a wearable terminal for storing video and audio data according to biometric information of a user and a system therefor.

### Technical Solution

To achieve these and other advantages and in accordance with the purpose of the present invention, as embodied and broadly described, according to one embodiment, a wearable terminal includes a communication unit configured to perform communication with at least one external device, a memory configured to store at least one of a captured image and detected sound, a biometric information detection unit configured to detect biometric information from a body of a user, and a controller configured to control the communication unit to transmit at least one of the stored image and the sound to the external device according to the detected biometric information.

In this case, the biometric information detection unit can include at least one of a camera configured to capture pupil of the user and a sensor configured to detect pulse of the user.

And, the controller controls the communication unit to transmit at least one of the stored image and the sound to the external device according to a change of at least one selected from the group consisting of a size of pupil of the user, movement of pupil of the user, the number of blinks of eyes of the user, and pulse of the user.

And, the controller controls the communication unit to transmit at least one of the stored image and the sound, which are stored before and after specific time on the basis of time at which the biometric information is changed, to the external device.

To further achieve these and other advantages and in accordance with the purpose of the present invention, according to a different embodiment, a data storing system includes a wearable terminal configured to store at least one of a captured image and detected sound and transmit at least one of the stored image and the sound according to biometric information detected from a body of a user and a storing device configured to store the image and the sound transmitted from the wearable terminal.

### DESCRIPTION OF DRAWINGS

FIG. 1 is a block diagram for explaining an example of a data storing system according to the present invention;

FIG. 2 is a block diagram for explaining an example of a mobile terminal according to the present invention;

FIG. 3 is a diagram for an example of a wearable terminal according to the present invention;

FIG. 4 is a block diagram for a part of a wearable terminal shown in FIG. 3;

FIG. 5 is a flowchart for explaining a method of storing data using a data storing system shown in FIG. 1;

FIG. 6 is a diagram for a different example of a wearable terminal according to the present invention;

FIG. 7 is a block diagram for a part of a wearable terminal shown in FIG. 6;

FIG. 8 is a diagram for a change of a pupil of a user;

FIG. 9 is a diagram for an example of utilizing a wearable terminal.

### BEST MODE

### Mode for Invention

Since the present invention may have various modifications and a plurality of embodiments, specific embodiments are explained in detail with reference to drawings. Yet, the present invention may be non-limited by a specific embodiment. Hence, it is necessary to be understood that the present invention includes all modifications, equivalents and substitutes included in the idea and the technical scope of the present invention.

Moreover, a terminology, each of which includes such an ordinal number as 1st, 2nd and the like, may be used to describe various components. In doing so, the various components should be non-limited by the corresponding terminologies, respectively. The terminologies are only used for the purpose of discriminating one component from other components.

In case that one component is mentioned as ‘connected to’ or ‘accessing’ another component, it may be connected to or access the corresponding component in direct. Yet, new component(s) may exist in between. On the other hand, in case that one component is mentioned as ‘directly connected to’ or ‘directly accessing’ another component, it should be understood that new component(s) may not exist in between.

Terminologies used in the present specification are used to explain a specific embodiment only. The present invention is not limited by the terminologies. And, the singular number representation used in the present specification may include the plural number representation unless mentioned clearly and differently in context.

In the present application, such a terminology as ‘comprise’, ‘include’ and the like should be construed not as excluding existence of one or more characteristics, a number, a step, an operation, a component, a part or a combination thereof or a possibility of addition in advance but as designating existence of a characteristic, a number, a step, a component, a part or a combination thereof written on the disclosure.

In general, a suffix such as “module” and “unit” may be used to refer to elements or components. Use of such a suffix herein is merely intended to facilitate description of the specification, and the suffix itself is not intended to give any special meaning or function.

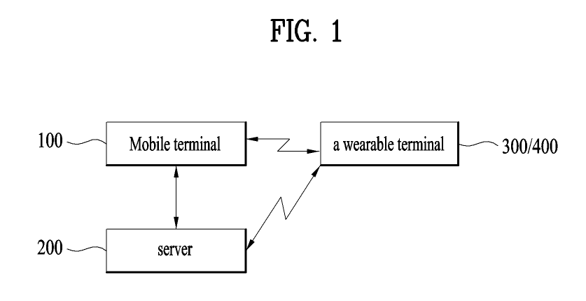

FIG. 1 is a block diagram for explaining an example of a data storing system according to the present invention. As shown in FIG. 1, the data storing system according to the present invention includes a mobile terminal 100, a server 200, and a wearable terminal 300/400.

A mobile terminal explained in the present specification may include one selected from the group consisting of a mobile phone, a smartphone, a laptop computer, a terminal used for digital broadcast, a PDA (personal digital assistant), a PMP (portable multimedia player), a navigation, a slate PC, a tablet PC, and an ultra-book.

Except a case capable of being applied to a mobile terminal only, it is apparent to those skilled in the art that a configuration according to embodiments written in the present specification can also be applied to a fixed terminal such as a digital TV, a desktop computer, a digital signage and the like.

A wearable terminal 300/400 can be configured by a form such as a smartwatch, a smart glass, or a HMD (head mounted display), by which the present invention may be non-limited. The wearable terminal may correspond to a terminal capable of being worn on a user. And, the wearable terminal 300/400 can communicate not only with a mobile terminal 100 but also with a server 200. Besides, the wearable terminal can transceive data with a storing device of a different form capable of performing communication.

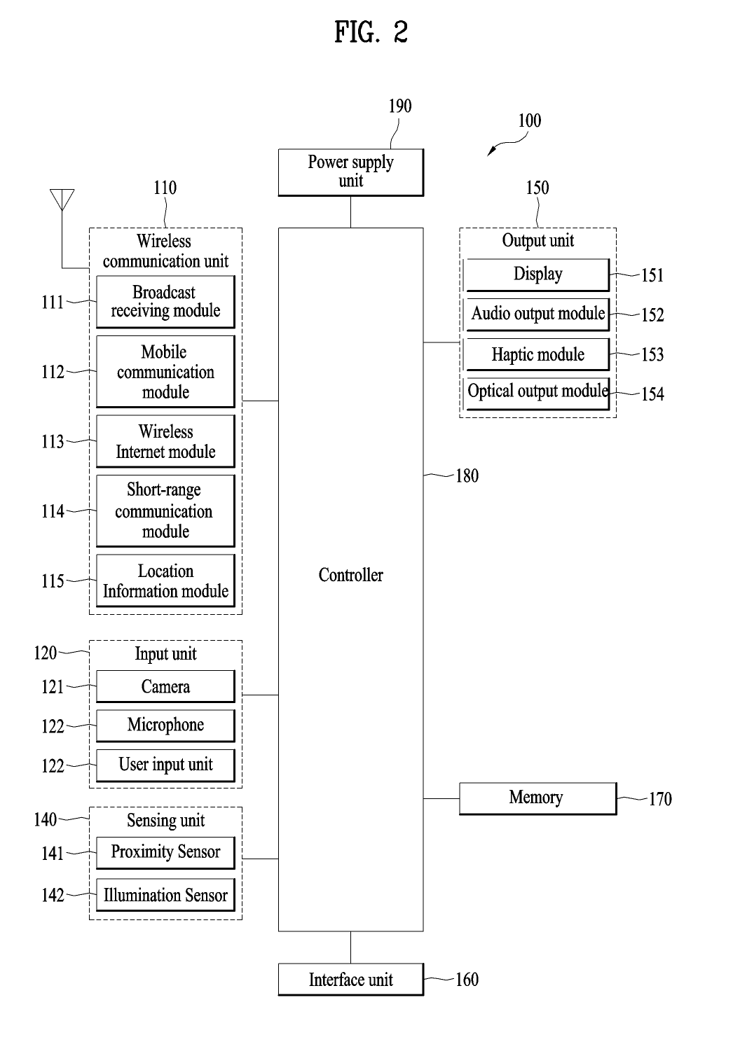

FIG. 2 is a block diagram for explaining an example of a mobile terminal according to the present invention.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 2, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 2, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, informations and the like inputted or outputted through the above-mentioned components and/or runs application programs saved in the memory 170, thereby processing or providing a user with appropriate informations and/or functions.

The controller 180 may provide or process information or functions appropriate for a user by processing signals, data, information and the like, which are input or output by the various components depicted in FIG. 2, or activating application programs stored in the memory 170. As one example, the controller 180 controls some or all of the components illustrated in FIG. 2 according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 2, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIG. 2, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the 1st audio output unit 152a, the 2nd audio output unit 152b, the proximity sensor 141, the illumination sensor 142, the light output unit 154, the 1st camera 121a, the 2nd camera 121b, the 1st manipulating unit 123a, the 2nd manipulating unit 123b, the microphone 122, the interface unit 160, and the like.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 2). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

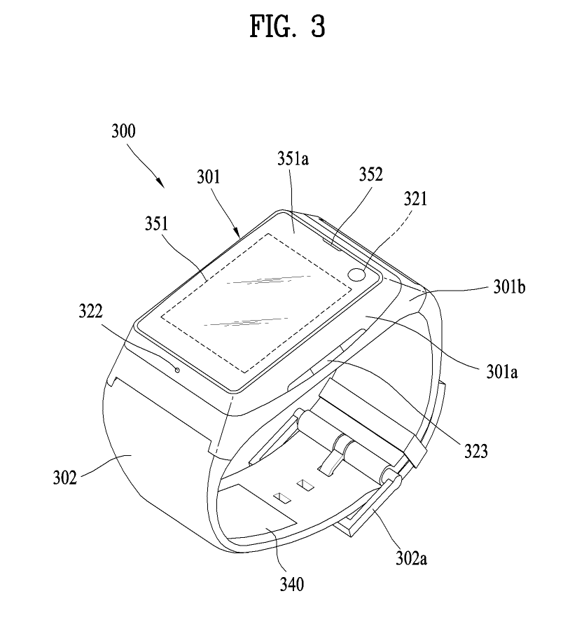

FIG. 3 is a perspective diagram for an example of a wearable terminal 300 of a watch type according to the present invention.

Referring to FIG. 3, a watch-type wearable terminal 300 includes a main body 301 including a display unit 351 and a band 302 configured to be worn on a wrist in a manner of being connected to the main body 301.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is located at the front side of the main body 301 so that displayed information is viewable to a user. In some embodiments, the display unit 351 includes a touch sensor so that the display unit can function as a touch screen. As illustrated, window 351a of the display unit 351 is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, the display unit may function as a user input unit 323. Hence, a separate key may not be included in the main body 301.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

And, a biometric information detection unit 303 for detecting biometric information of a user, i.e., pulse, is installed in the inside of the band 302. The biometric information detection unit 303 includes a film-type pressure sensor. The film-type pressure sensor is electrically connected to the main body 301 via an electric wire (not depicted) installed in the inside of the band 302.

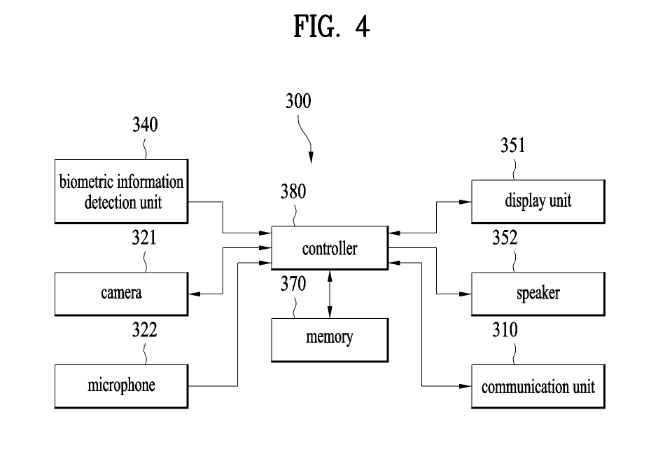

FIG. 4 is a block diagram for a part of a wearable terminal shown in FIG. 3.

As shown in FIG. 4, a biometric information detection unit 340 is configured to detect pulse from a wrist of a user. The biometric information detection unit can be configured with a sensor of a different form instead of a film-type pressure sensor.

A camera 321 processes a picture frame such as a still image or a video obtained by an image sensor in a video call mode or a capturing mode. A processed picture frame can be displayed on the display unit 351. Meanwhile, the camera 321 can be configured to continuously capture images while a wearable terminal 300 is maintained in a state of being turned on.

A microphone 322 processes an external audio signal into an electrical voice data. A processed voice data can be variously utilized according to a function performed by the wearable terminal 300 (or an application program executed in the wearable terminal). Meanwhile, the microphone 322 can be configured to continuously detect voice or sound while the wearable terminal 300 is maintained in a state of being turned on.

The display unit 351 displays (outputs) information processed in the mobile terminal 100 or the wearable terminal 300. For instance, the display unit 351 can display information on an execution screen of an application program executed in the wearable terminal 300 or UI (user interface), GUI (graphic user interface) information according to the information on the execution screen.

A speaker 352 can output audio data received from a communication unit 310 or audio data stored in a memory 370. The speaker 352 can also output an audio signal related to a function (e.g., call signal reception sound, message reception sound) performed in the wearable terminal 300.

The communication unit 310 is configured to perform short range communication. The communication unit can support short range communication using at least one selected from the group consisting of Bluetooth™, RFID (radio frequency identification), IrDA (infrared data association), UWB (ultra wideband), ZigBee, NFC (near field communication), Wi-Fi (wireless-fidelity), and Wi-Fi Direct. The communication unit 310 can support wireless communication between the wearable terminal 300 and a wireless communication system, between the wearable terminal 300 and a mobile terminal 100, or between the wearable terminal 300 and a network at which a mobile terminal (or am external server) is located via wireless personal area networks.

A memory 370 can store programs to support operations of the controller 380 and temporarily store input/output data (for example, phonebook, messages, still images, videos, etc.). The memory 370 may temporarily store an image captured by the camera 321 and voice and sound detected by the microphone 332. And, the memory 370 can store data related to various patterns of vibrations and audio which are outputted in response to touch inputs on the touch screen.

The memory 370 may include one or more types of storage mediums including a Flash memory, a hard disk, a multimedia card micro type, a card-type memory (e.g., SD or XD memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The wearable terminal 300 may also be connected with a web storage configured to perform a storing function of the memory 370 on the Internet.

The controller 380 controls the communication unit 310 to transmit at least one of an image and sound temporarily stored in the memory 370 to an external storing device, e.g., at least one selected from the group consisting of a mobile terminal 100, a server 200, a web storage, a USB drive, a HDD, and an SDD, according to a change of at least one of pressure and a period of pulse detected by the biometric information detection unit 340. And, the controller 380 can store at least one of the image and the sound temporarily stored in the memory 370 in a different memory (not depicted) of the wearable terminal 300 instead of the external storing device. The controller 380 reads at least one of the image and the sound stored in the storing device according to a request of a user and outputs at least one of the image and the sound to the display unit 351 or the speaker 352.

In the following, embodiments related to a control method capable of being implemented in the wearable terminal 300 are explained with reference to the attached drawings.

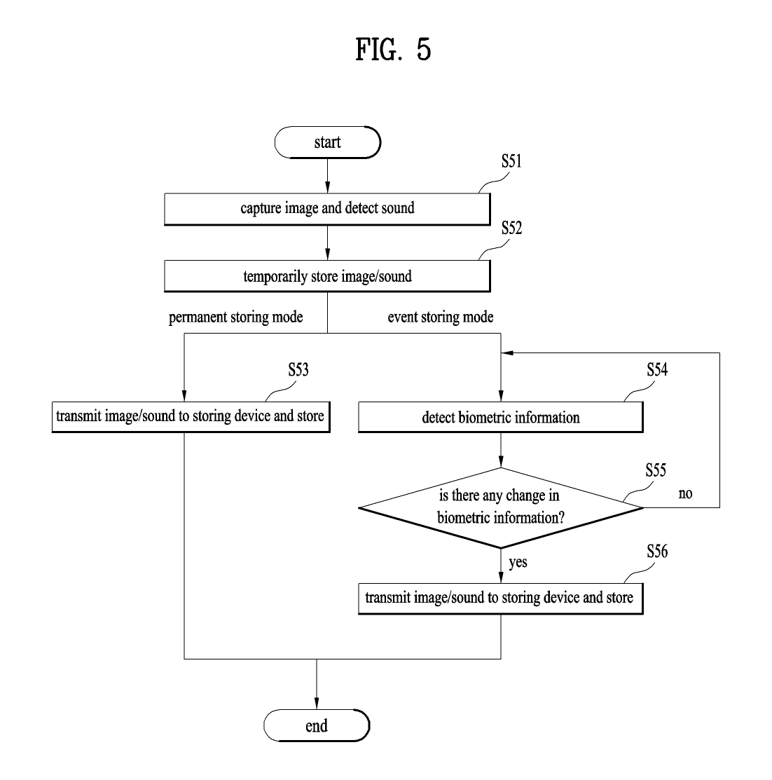

As shown in FIG. 5, first of all, the camera 321 captures an image while the wearable terminal 300 is maintained in a state of being turned on and the microphone 322 detects sound while the wearable terminal 300 is maintained in a state of being turned on [S51]. In this case, it may be able to configure one of the camera 321 and the microphone 322 to operate only.

The controller 380 temporarily stores one of the images captured by the camera 321 and the sound detected by the microphone 322 in the memory 370 [S52]. In this case, the controller 380 can store the image and the sound in the memory 370 in a certain time unit. For example, the controller can temporarily store the image and the sound in the memory 370 in a file form of time unit such as 1 minute, 3 minutes, 5 minutes or the like.

When the wearable terminal is configured with a permanent storing mode, the controller 380 controls the communication unit 310 to transmit at least one of temporarily stored image and sound to an external storing device, for example, at least one selected from the group consisting of a mobile terminal 100, a server 200, a web storage, a USB drive, a HDD, and an SDD. And, the transmitted image or the sound is stored in a memory of the external storing device, e.g., a memory 170 of the mobile terminal 100 [S53]. In this case, the memory 170 sequentially stores images and sounds continuously transmitted in a certain time unit and the image and the sounds include information indicating time at which the image is captured and time at which the sound is recorded. And, the controller 380 can store at least one of the temporarily stored image and the sound in a different memory (not depicted) of the wearable terminal 300 instead of the external storing device.

Meanwhile, when the wearable terminal is configured with an event storing mode, the controller 380 controls the biometric information detection unit 340 to detect pulse of a user [S54] and determines whether or not there is a change in pressure and a period of the detected pulse [S55]. If an amount of change for at least one of the pressure and the period of the pulse exceeds a threshold, the controller 380 controls the communication unit 310 to transmit at least one of temporarily stored image and sound to an external storing device. In this case, the controller 380 controls the communication unit 310 to transmit at least one of an image and sound temporarily stored before specific time and after the specific time on the basis of time at which the pulse is changed. Subsequently, the transmitted image or the sound is stored in a memory of an external device, e.g., the memory 170 of the mobile terminal 100 [S56]. In this case, the stored image and the sounds include information indicating time at which the image is captured and time at which the sound is recorded. And, the controller 380 can store at least one of the temporarily stored image and the sound in a different memory (not depicted) of the wearable terminal 300 instead of the external storing device.

As mentioned in the foregoing description, since an image and sound are stored according to a change of pulse of a user, when an accident or an event occurs on the user, an image or sound at the time of the accident or the event can be automatically stored. Subsequently, the controller 380 reads at least one of the images and the sound stored in a storing device according to a request of the user and may be then able to output the image or the sound via the display unit 351 or the speaker 352.

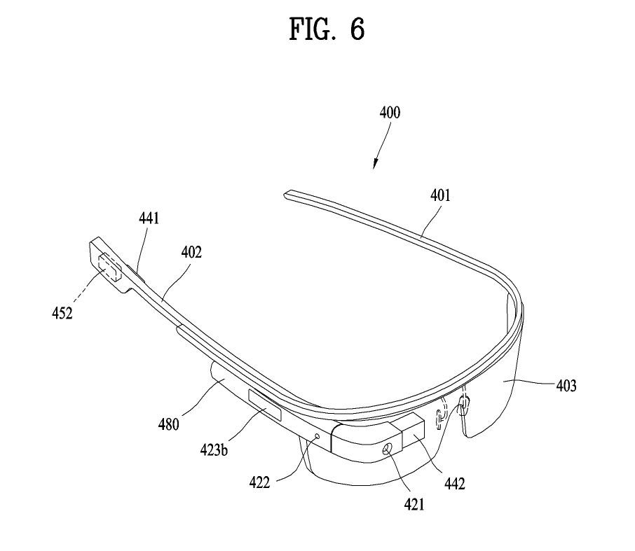

FIG. 6 is a perspective diagram for an example of a glass-type mobile terminal 400 according to the present invention.

The glass-type mobile terminal 400 can be wearable on a head of a human body and provided with a frame (case, housing, etc.) therefor. The frame may be made of a flexible material to be easily worn. The present drawing shows an example that the frame includes a first frame 401 and a second frame 402, which are made of different materials, respectively.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 6 illustrates that the control module 480 is installed in the frame part on one side of the head, but other locations are possible.

A first camera 442 is deployed in the vicinity of a left eye or a right eye and the first camera is configured to capture an eye, pupil, skin color and the like of a user. A second camera 421 is deployed in the vicinity of a left eye or a right eye and the second camera is configured to capture an image of a front side. Since the camera 421 is located in the vicinity of an eye, the camera 421 can obtain a scene at which a user is looking as an image. In FIG. 6, the camera 442/421 is installed in a control module 480, by which the present invention may be non-limited. The camera 442/421 can be installed in the frame and a plurality of cameras can be installed to obtain a 3D image.

A display unit (not depicted) can be further included. The display unit can be configured in a HMD (head mounted display) form at a position near the first camera 442. The HMD form refers to display techniques by which a display is mounted to a head to show an image directly in front of a user's eyes. In order to provide an image directly in front of the user's eyes when the user wears the glass-type mobile terminal 400, the display unit may be located to correspond to either or both of the left and right eyes.

The glass-type wearable terminal 400 can include a user input unit 441/423b configured to receive an input of a control command. The user input unit 441/423b can adopt any scheme capable of operating the wearable terminal in a manner that a user operates the wearable terminal with a tactile sense such as touch, push and the like. FIG. 6 shows an example that user input unit 441/423b of a push input scheme and a touch input scheme are installed in the frame and the control module 480, respectively. In this case, the user input unit 441 may function as a biometric information detection unit 440. In order to make the user input unit 441 to be contacted with a body of a user, the user input unit 441 is positioned at the inside of a second frame 402. The user input unit 441 is configured to detect pulse from a part near an ear of a user. The user input unit 441 can be configured by a sensor of a different form as well as a film-type pressure sensor.

And, the glass-type mobile terminal 400 can include a microphone 422 configured to receive a sound input and process the sound input into an electrical voice data and an audio output module 452 configured to output audio. The audio output module 452 can be configured to deliver audio using a general audio output scheme or a bone conduction scheme. When the audio output module 452 is implemented using the bone conduction scheme, if a user wears the mobile terminal 400, the audio output module 452 is pressed against the head and delivers audio by vibrating the scull.

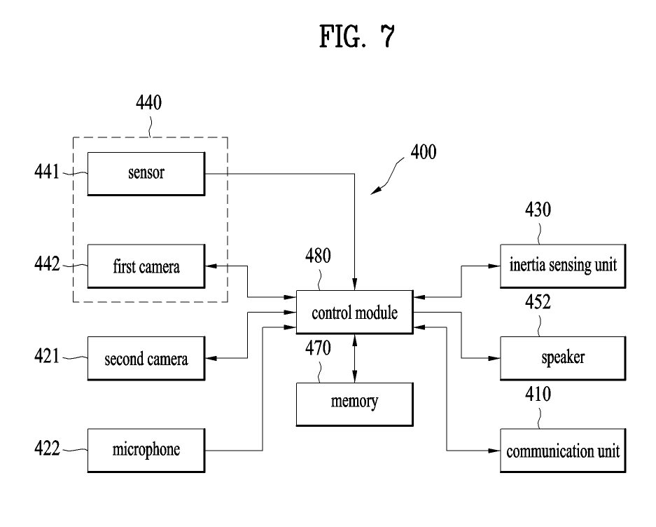

FIG. 7 is a block diagram for a part of a wearable terminal shown in FIG. 6.

As shown in FIG. 7, biometric information detection unit 440 includes a sensor 441 configured to detect pulse from a body of a user and a first camera 442 configured to capture eyes, pupil, skin color and the like of the user.

A second camera 421 processes such a picture frame as a still image and a video obtained by an image sensor in a video call mode or a capture mode. A processed picture frame can be displayed on a display unit (not depicted). Meanwhile, the second camera 421 can be configured to continuously capture images while a wearable terminal 400 is maintained in a state of being turned on.

A microphone 422 processes an external audio signal into an electrical voice data. A processed voice data can be variously utilized according to a function performed by the wearable terminal 400 (or an application program executed in the wearable terminal). Meanwhile, the microphone 422 can be configured to continuously detect voice or sound while the wearable terminal 400 is maintained in a state of being turned on.

An inertia sensing unit 430 includes at least one selected from the group consisting of an acceleration sensor, a G-sensor, and a gyroscope sensor to measure acceleration and a slope of the wearable terminal 400. A signal outputted from the inertial sensing unit 430 is used for determining a collision of a user or an impact.

A speaker 452 can output audio data received from a communication unit 410 or audio data stored in a memory 470. The speaker 452 can also output an audio signal related to a function (e.g., call signal reception sound, message reception sound) performed in the wearable terminal 400.

The communication unit 410 is configured to perform short range communication. The communication unit can support short range communication using at least one selected from the group consisting of Bluetooth™, RFID (radio frequency identification), IrDA (infrared data association), UWB (ultra wideband), ZigBee, NFC (near field communication), Wi-Fi (wireless-fidelity), and Wi-Fi Direct. The communication unit 410 can support wireless communication between the wearable terminal 400 and a wireless communication system, between the wearable terminal 400 and a mobile terminal 100, or between the wearable terminal 400 and a network at which a mobile terminal (or am external server) is located via wireless personal area networks.

A memory 470 can store programs to support operations of a control module 480 and temporarily store input/output data (for example, phonebook, messages, still images, videos, etc.). In particular, the memory 470 may temporarily store an image captured by the second camera 421 and voice and sound detected by the microphone 422. And, the memory 470 can store data related to various patterns of vibrations and audio.

The memory 470 may include one or more types of storage mediums including a Flash memory, a hard disk, a multimedia card micro type, a card-type memory (e.g., SD or XD memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The wearable terminal 400 may also be connected with a web storage configured to perform a storing function of the memory 470 on the Internet.

The control module 480 controls the communication unit 410 to transmit at least one of an image and sound temporarily stored in the memory 470 to an external storing device, e.g., at least one selected from the group consisting of a mobile terminal 100, a server 200, a web storage, a USB drive, a HDD, and an SDD, according to a change of at least one selected from the group consisting of pulse pressure, a period of pulse, a size of pupil, movement of pupil, and the number of blinks of eyes detected by the biometric information detection unit 440. And, the control module 480 can store at least one of the temporarily stored image and the sound in a different memory (not depicted) of the wearable terminal 400 instead of the external storing device. The control module 480 reads at least one of the image and the sound stored in the storing device according to a request of a user and outputs at least one of the image and the sound to the display unit (not depicted) or the speaker 452.

In the following, embodiments related to a control method capable of being implemented in the wearable terminal 400 are explained with reference to the attached drawings.

As shown in FIG. 5, first of all, the second camera 421 captures an image while the wearable terminal 400 is maintained in a state of being turned on and the microphone 422 detects sound while the wearable terminal 400 is maintained in a state of being turned on [S51]. In this case, it may be able to configure one of the camera 421 and the microphone 422 to operate only.

The control module 480 temporarily stores one of the images captured by the camera 421 and the sound detected by the microphone 422 in the memory 470 [S52]. In this case, the control module 480 can store the image and the sound in the memory 470 in a certain time unit. For example, the control module can temporarily store the image and the sound in the memory 470 in a file form of time unit such as 1 minute, 3 minutes, 5 minutes or the like.

When the wearable terminal is configured with a permanent storing mode, the control module 480 controls the communication unit 410 to transmit at least one of temporarily stored image and sound to an external storing device, for example, at least one selected from the group consisting of a mobile terminal 100, a server 200, a web storage, a USB drive, a HDD, and an SDD. And, the transmitted image or the sound is stored in a memory of the external storing device, e.g., a memory 170 of the mobile terminal 100 [S53]. In this case, the memory 170 sequentially stores images and sounds continuously transmitted in a certain time unit and the image and the sounds include information indicating time at which the image is captured and time at which the sound is recorded. And, the control module 480 can store at least one of the temporarily stored image and the sound in a different memory (not depicted) of the wearable terminal 400 instead of the external storing device.

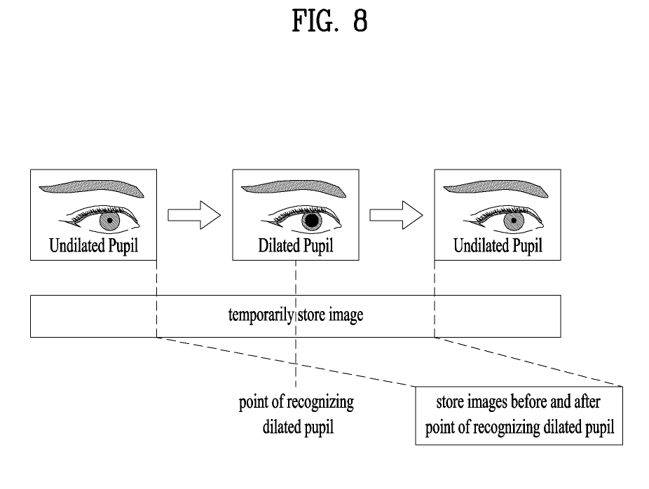

Meanwhile, when the wearable terminal is configured with an event storing mode, the control module 480 controls the biometric information detection unit 440 to detect at least one or more biometric information of a user, e.g., pressure of pulse, a period of pulse, a size of pupil, movement of pupil, and the number of blinks of eyes per prescribed time [S54] and determines whether or not there is a change in the detected biometric information [S55]. If an amount of change for at least one of the pressure of pulse, the period of pulse, the size of pupil, the movement of pupil, and the number of blinks of eyes per prescribed time exceeds a threshold, the control module 480 controls the communication unit 410 to transmit at least one of temporarily stored image and sound to an external storing device. For example, as shown in FIG. 8, if a change of the size of pupil of the user exceeds the threshold, the control module 480 controls the communication unit 410 to transmit at least one of an image and sound temporarily stored before specific time and after the specific time on the basis of time at which the size of pupil is changed. Subsequently, the transmitted image or the sound is stored in a memory of an external device, e.g., the memory 170 of the mobile terminal 100 [S56]. In this case, the stored image and the sounds include information indicating time at which the image is captured and time at which the sound is recorded. And, the control module 480 can store at least one of the temporarily stored image and the sound in a different memory (not depicted) of the wearable terminal 400 instead of the external storing device.

And, when the wearable terminal is configured with the event storing mode, the control module 480 can additionally store at least one of the temporarily stored images and the sound in an external/internal storing device according to a change of at least one of a slope and acceleration measured by the inertial sensing unit 430. For example, if a slope temporarily increases and a change of acceleration is greater than a threshold value, the control module 480 stores at least one of the temporarily stored image and the sound in the external/internal storing device.

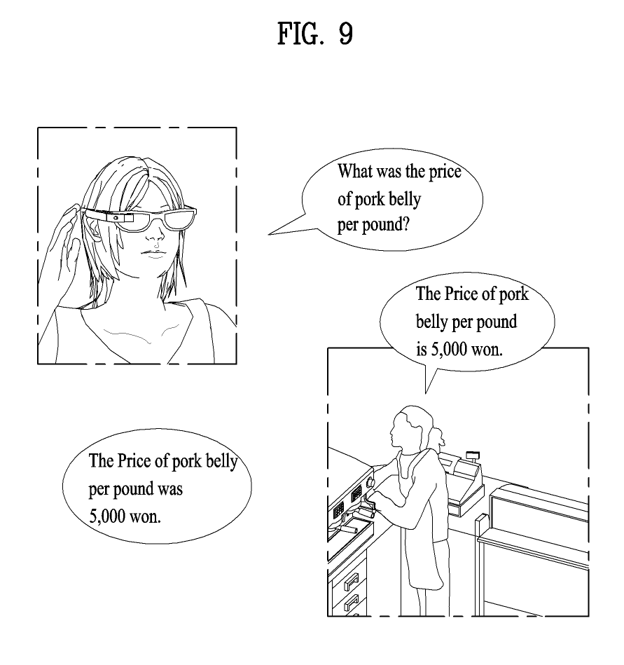

Subsequently, the control module 480 reads at least one of the image and the sound stored in the storing device according to a request of a user and may be then able to display at least one of the image and the sound on a display unit or a speaker 452. For example, as shown in FIG. 9, when a user asks about price of pork belly in the market, the control module 480 recognizes voice of the user, searches for an image/voice data including such a word (voice) as “pork belly” among data stored in the external/internal storing device, and may be then able to show the image/voice data to the user. Moreover, the control module 480 checks voice for the price of pork belly and may be then able to inform the user of the price.

It is apparent to those skilled in the art that the present invention is able to be materialized into a specific form in a scope not deviating from the idea and the essential characteristic of the present invention.

Meanwhile, according to the aforementioned present invention, the aforementioned method can be implemented with a code readable by a computer in a recording media in which a program is recorded. The examples of the recording media readable by the computer may include a ROM, a RAM, a CD-ROM, a magnetic tape, a floppy disc, an optical data storing device and the like. And, implementing in a form of a carrier wave (e.g., transmission via the internet and the like) is also included. The computer may include a control unit 180 of a terminal.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

What is claimed is:

1. A wearable terminal, comprising:
a communication unit configured to perform communication with at least one external device;
a memory configured to store at least one of a captured image and detected sound;
a biometric information detection unit configured to detect biometric information from a body of a user; and
a controller configured to control the communication unit to transmit at least one of the stored image and the sound to the external device according to the detected biometric information.

2. The wearable terminal of claim 1, wherein the biometric information detection unit includes a camera configured to capture pupil of the user.

3. The wearable terminal of claim 1, wherein the biometric information detection unit includes a sensor configured to detect pulse of the user.

4. The wearable terminal of claim 1, wherein the controller is configured to transmit at least one of the stored image and the sound to the external device according to a change of a size of pupil of the user.

5. The wearable terminal of claim 1, wherein the controller is configured to transmit at least one of the stored image and the sound to the external device according to a change of movement of pupil of the user.

6. The wearable terminal of claim 1, wherein the controller is configured to transmit at least one of the stored image and the sound to the external device according to a change of the number of blinks of eyes of the user per prescribed time.

7. The wearable terminal of claim 1, wherein the controller is configured to transmit at least one of the stored image and the sound to the external device according to a change of pulse of the user.

8. The wearable terminal of claim 1, wherein the controller is configured to transmit at least one of the stored image and the sound to the external device according to a change of at least one of a slope and acceleration.

9. The wearable terminal of claim 1, wherein the controller is configured to transmit at least one of the stored image and the sound, which are stored before and after specific time on the basis of time at which the biometric information is changed, to the external device.

10. A data storing system, comprising:
a wearable terminal configured to store at least one of a captured image and detected sound and transmit at least one of the stored image and the sound according to biometric information detected from a body of a user; and
a storing device configured to store the image and the sound transmitted from the wearable terminal.

11. The data storing device of claim 10, wherein the wearable terminal is configured to transmit at least one of the stored image and the sound according to a change of a size of pupil of the user.

12. The data storing device of claim 10, wherein the wearable terminal is configured to transmit at least one of the stored image and the sound according to a change of movement of pupil of the user.

13. The data storing device of claim 10, wherein the wearable terminal is configured to transmit at least one of the stored image and the sound according to a change of the number of blinks of eyes of the user per prescribed time.

14. The data storing device of claim 10, wherein the wearable terminal is configured to transmit at least one of the stored image and the sound according to a change of pulse of the user.

15. The data storing device of claim 10, wherein the wearable terminal is configured to transmit at least one of the stored image and the sound according to a change of at least one of a slope and acceleration of the wearable terminal.

16. The data storing device of claim 10, wherein the wearable terminal is configured to transmit at least one of the stored image and the sound, which are stored before and after specific time on the basis of time at which the biometric information is changed.
